(19) United States
(12) Patent Application Publication
(10) Pub. No.: US 2021/0293126 A1
(43) Pub. Date: Sep. 23, 2021

(54) Plasma Pulse Device for Shock Wave Stimulation of Wells, Deposits, and Boreholes

(71) Applicant: Pledge Petroleum Corp., Houston, TX (US)

(72) Inventors: Trent Hunter, Calgary (CA); Thomas A. Olson, Maryville, TN (US)

(73) Assignee: Pledge Petroleum Corp., Houston, TX (US)

(21) Appl. No.: 16/323,364

(22) PCT Filed: Aug. 4, 2017
(86) PCT No.: PCT/US2017/045451

§ 371 Date: Feb. 5, 2019

Related U.S. Application Data
(60) Provisional application No. 62/371,490, filed on Aug. 5, 2016.

(51) Int. Cl. E21B 43/25; H05H 1/48; E21B 47/18

(52) U.S. Cl. CPC E21B 43/25; E21B 47/18; H05H 1/48

(57) ABSTRACT

A plasma pulse device for producing fluid shock waves includes a shooting head having a positive electrode and a negative electrode and at least one emitter window, a metal conductor configured to be positioned into and ablated in the shooting head, and a feeder having a drive mechanism for supplying the metal conductor into the shooting head, the drive mechanism including two motors, the metal conductor being at least partially positioned in between the two motors. A method for generating shock waves includes feeding a metal conductor into a shooting head of a plasma pulse device using a drive mechanism including two motors, the metal conductor being at least partially positioned in between the two motors, contacting the metal conductor to a first electrode positioned in the shooting head, and delivering electricity to the metal conductor through the first electrode and causing the metal conductor to ablate.

### CROSS-REFERENCE TO RELATED APPLICATIONS

This application claims priority to and the benefit of U.S. Provisional Patent Application No. 62/371,490, filed Aug. 5, 2016, which is incorporated herein by reference in its entirety.

### FIELD OF THE INVENTION

The present invention, according to some embodiments, relates to a device for generating a plasma-induced shock wave which may be utilized to stimulate wells (e.g., hydrocarbon wells).

### BACKGROUND OF THE INVENTION

Fluid flow into or out of wells and boreholes, for example hydrocarbon wells, may become blocked by obstructions or plugs (also known as “damage”), which limits the amount of hydrocarbons that can be recovered from the surrounding deposits. Remediating the damage increases the deposit permeability and improves hydrocarbon mobility and recovery.

Numerous methods for enhancing hydrocarbon recovery from hydrocarbon wells have been disclosed. These methods include, for instance, various mechanical, chemical, microbiological, or thermal processes. Some such processes rely on the use of various agent-assisted processes, for example, the injection of steam, foam surfactants, gases, chemical reactants, biological agents, etc. to stimulate the well. However, such agents may be toxic and/or deleterious to the environment. Other methods have been disclosed which use ultrasonic, acoustic, electrohydraulic, electric hydro-pulse or electromagnetic emitter devices to improve the permeability of the porous media surrounding the well.

U.S. Pat. No. 9,181,788 and U.S. Patent Application Publication No. 2014/0027110, which are incorporated herein by reference in their entirety, describe a plasma source for generating oscillations that may be used for stimulating wells. The plasma source utilizes an exploding metal conductor for creating harmonics or resonance to induce enhanced liquid inflow into wellbores from deposits. The oscillations produced by the plasma source are wide-band and elastic.

### BRIEF SUMMARY OF THE INVENTION

The present invention, according to some embodiments, provides an improved plasma pulse device configured to generate a plasma-induced shock wave that may be used to stimulate wells, deposits, and boreholes, for example, oil or other hydrocarbon wells. In some embodiments, a plasma pulse device according to the present invention is configured to generate directed, narrow band, inelastic shock waves capable of remediating wellbore damage.

In some embodiments, a plasma pulse device for producing fluid shock waves includes a shooting head having a positive electrode and a negative electrode and at least one emitter window, a metal conductor configured to be positioned into and ablated in the shooting head, and a feeder having a drive mechanism for supplying the metal conductor into the shooting head, the drive mechanism including two motors, the metal conductor being at least partially positioned in between the two motors. In some embodiments, the plasma pulse device is configured to generate inelastic shock waves when the metal conductor is ablated in the shooting head. In some embodiments, the plasma pulse device is configured to generate ultrasonic shock waves when the metal conductor is ablated in the shooting head. In some embodiments, the shooting head includes no more than two emitter windows.

In some embodiments, the feeder further includes a chassis having a guide configured to direct the metal conductor to the drive mechanism, the metal conductor being at least partially positioned within the guide. In some embodiments, the feeder includes a spool rotatably mounted on the chassis, and wherein the guide is positioned between the spool and the drive mechanism. In some embodiments, the metal conductor includes a wire which is at least partially wound around the spool. In some such embodiments, the metal conductor is a stainless steel wire having a diameter of at least 0.020 inches.

In further embodiments, the negative electrode includes an aperture configured to receive the metal conductor therethrough. In some embodiments, at least one of the positive electrode and the negative electrode are made from a copper tungsten alloy. In some embodiments, the plasma pulse device includes an energy storage device electrically coupled to the positive electrode and configured to discharge electricity to the positive electrode. The energy storage device, in some embodiments, includes one or more capacitors. In some embodiments, the energy storage device is coupled to the positive electrode by a trigger device, for example, a gas discharge actuator. In some such embodiments, the positive electrode includes a slotted end, the trigger device is connected to the positive electrode by a conductive strap, and the conductive strap is inserted within the slotted end of the positive electrode. In some embodiments, the energy storage device is electrically connected to a DC power supply by a conveyance cable. The energy storage device, in some embodiments, has a charging time that is independent of a length of the conveyance cable. In yet further embodiments, the plasma pulse device further includes telemetry equipment, for example an FSK beacon. In some embodiments, the plasma pulse device includes a sensor for detecting at least one of plasma discharge, acoustic signals, and/or percussive forces.

In some embodiments, the present invention provides a plasma pulse device configured for producing fluid shock waves for remediating wellbore damage having one or more of the following features: singularity or duality of emitter openings; optionality for choosing any pulse discharge time setting; optionality to choose any high voltage level of the capacitors to influence the intensity of the discharge shock wave; capability to be operated both vertically and horizontally; capability to be operated in open holes and in any wellbores including those with manufactured slotted screens; capability to propagate both a high velocity shock waves and low velocity acoustic waves; capability to be used as an energy source to be detected by seismic monitoring sensors for improved geophysical modelling of the subsurface; two stepper motor drive mechanism configured to remove bias of an exploding bridge wire between electrodes and to push the exploding bridge wire with more force and to minimize load circuit resistance; capability to operate with sensors such as the acoustic sensor that enables independent downhole positive plasma pulse detection to occur; dual metallurgy rails and high rail connection surface area configured to lower load circuit resistance; copper tungsten alloy electrodes configured to enable low weldability with the exploding bridge wire during discharge; negative electrode with higher tolerances to the exploding bridge wire to lower load circuit resistance; two stepper motor drive configured to enable a stiffer exploding bridge wire to be used for ablation; two stepper motor drive configured to enable a force high enough to kink the EBW when it comes in contact with the positive electrode; two stepper motor drive configured with a cantilever spring and serrated drive wheels configured to prevent exploding bridge wire slippage; wire feed chassis configured with guide tubes (fixed and inserted) to condition the exploding bridge wire before and after it contacts the twin drive wheels; electronically triggered ceramic gas actuator configured to significantly improve shock wave intensity and peak output power; low electrical losses between ceramic gas actuator to positive electrode connection; and a 55 kHz FSK beacon precisely timed to the discharge of the pulse tool.

In further embodiments, the present invention provides a method for generating shock waves, for example, narrow-band, inelastic shockwaves, which may be used to remediate wellbore damage. In some embodiments, a method for generating shock waves includes feeding a metal conductor into a shooting head of a plasma pulse device using a drive mechanism including two motors, the metal conductor being at least partially positioned in between the two motors, contacting the metal conductor to a first electrode (e.g., a positive electrode) positioned in the shooting head, and delivering electricity to the metal conductor through the first electrode and causing the metal conductor to ablate. In some embodiments, feeding the metal conductor into the shooting head comprises passing the metal conductor through a second electrode (e.g., a negative electrode). In some embodiments, the first electrode and/or second electrode is made from a copper tungsten alloy. In some embodiments, the metal conductor is a stainless steel wire having a diameter of at least 0.020 inches. In some embodiments, the shooting head includes no more than two emitter windows.

In some embodiments, delivering electricity to the metal conductor comprises discharging an energy storage device electrically coupled to the first electrode. In some embodiments, the method further includes charging the energy storage device using a DC power supply. In some embodiments, the energy storage device comprises one or more capacitors, and charging the energy storage device includes charging the one or more capacitors in less than ten seconds. In certain embodiments, the energy storage device is coupled to the first electrode by a trigger device, for example, a ceramic gas discharge actuator or spark gap.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention can be embodied in different forms and thus should not be construed as being limited to the illustrated embodiments set forth herein.

FIG. 1 is a diagram illustrating an arrangement of a plasma pulse device in accordance with an embodiment of the present invention;

FIG. 2A shows a perspective view of a shooting head of a plasma pulse device in accordance with an embodiment of the present invention;

FIG. 2B shows a side view of a shooting head of a plasma pulse device in accordance with an embodiment of the present invention;

FIG. 2C shows a cross-sectional view of the shooting head of FIG. 2B taken across the plane designated by line 2C-2C;

FIG. 3 shows graphs of relative trigger performance for a gas actuator and a mechanical actuator;

FIG. 4 is a diagram illustrating the electrical architecture of a plasma pulse device in accordance with an embodiment of the present invention;

FIGS. 5A-5C show views of a feeder of a plasma pulse device in accordance with an embodiment of the present invention;

FIG. 6A shows a diagram illustrating a portion of a plasma pulse device in accordance with an embodiment of the present invention which uses a twin motor drive mechanism;

FIG. 6B shows a diagram illustrating a portion of a plasma pulse which uses a push-type actuator drive mechanism;

FIG. 7 shows a partial view of a plasma pulse device in accordance with an embodiment of the present invention;

FIG. 8 shows a positive electrode of a plasma pulse device in accordance with an embodiment of the present invention; and

FIG. 9 shows a negative electrode of a plasma pulse device in accordance with an embodiment of the present invention.

### DETAILED DESCRIPTION

The present subject matter will now be described more fully hereinafter with reference to the accompanying Figures, in which representative embodiments are shown. The present subject matter can, however, be embodied in different forms and should not be construed as limited to the embodiments set forth herein. Rather, these embodiments are provided to describe and enable one of skill in the art. All publications, patent applications, patents, and other references mentioned herein are incorporated by reference in their entirety.

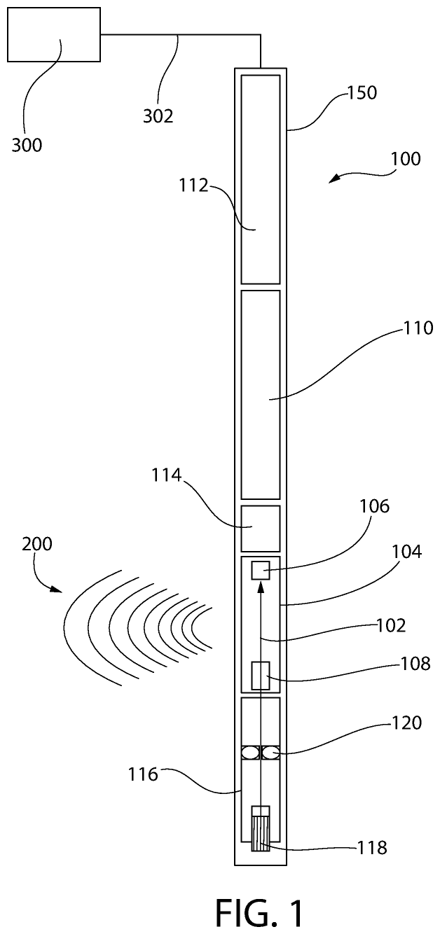

Referring to the drawings in detail, wherein like reference numerals indicate like elements throughout, there is shown in FIG. 1 an arrangement for a plasma pulse device, generally designated 100, in accordance with an exemplary embodiment of the present invention. Plasma pulse device 100, in certain embodiments, may be utilized to generate shock waves 200 to remediate damage in well bores (e.g., oil or other hydrocarbon wells) in order to improve permeability and fluid flow in the well bore. Plasma pulse device 100 is therefore preferably sized and shaped for insertion into a well bore according to some embodiments. The plasma pulse device 100 of the present invention may be used vertically (as generally illustrated in FIG. 1) or it may be used horizontally, or at any angle in between according to some embodiments.

In some embodiments, shock waves 200 are generated by plasma pulse device 100 through the ablation of a metal conductor 102 (e.g., an exploding bridge wire) and are emitted from a shooting head 104 of plasma pulse device 100. In some embodiments, ablation of metal conductor 102 is achieved when electrical energy is discharged via one or more electrodes through metal conductor 102 over a very short period of time (e.g., less than 5 microseconds) which in turn causes the temperature of metal conductor 102 to increase rapidly, exceed its melting point, and cause metal conductor 102 to explode or ablate. In certain embodiments, metal conductor 102 may be a stainless steel wire, for example, a 0.020 inch diameter 302/304 stainless steel wire. Other materials for metal conductor 102 may be used with pulse device 100 according to other embodiments. After each ablation cycle, additional metal conductor 102 may be fed into shooting head 104 such that plasma pulse device 100 may be configured to provide repeated, continuously applied shocked waves over a period of time sufficient to remediate the damage.

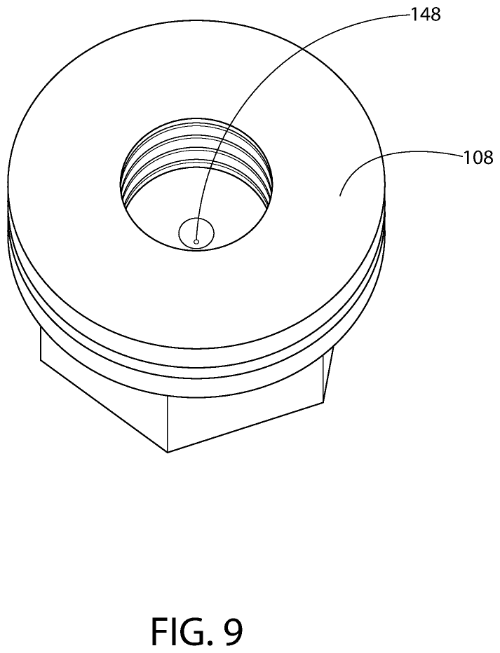

In some embodiments, shooting head 104 includes a first electrode 106 and a second electrode 108 which are spaced apart and each configured to contact metal conductor 102. In some embodiments, first electrode 106 is positioned at or proximate to a first end of shooting head 104, and second electrode 108 is positioned at or proximate a second end of shooting head 104. In some embodiments, metal conductor 102 may be inserted into shooting head 104 and spans the gap between first electrode 106 and second electrode 108 and makes contact with the two electrodes in order to complete a circuit during use. In some embodiments, as best seen in FIG. 9, second electrode 108 includes an aperture 148 through which metal conductor 102 is configured to pass. In some embodiments, aperture 148 of the second electrode 108 is sized to have tight tolerance around metal conductor 102. The tight tolerance may be, in some embodiments, a difference of less than 0.01 inches in the diameters of aperture 148 and metal conductor 102. For example, in some embodiments, aperture 148 may have a diameter of or about 0.028 inches for use with a metal conductor 102 having a diameter of or about 0.020 inches (i.e., a difference of 0.008 inches). Even smaller tolerances may be provided according to other examples. In some embodiments, the tight tolerances in the aperture 148 surrounding the metal conductor 102 may be optimized for electrical conductance and ablation, without welding and residual blast material retention, and to minimize load circuit resistance. In some embodiments, metal conductor 102 is fed into shooting head 104 through second electrode 108 until metal conductor 102 contacts first electrode 106. In some embodiments, first electrode 106 may include a contact surface for contacting metal conductor 102 which is, for example, circular or polygonal in shape. In some embodiments, metal conductor 102 is configured to make contact with the contact surface of first electrode 106 at or proximate the center of the contact surface. In some embodiments, the contact surface of first electrode 106 is hexagonal in shape. In some examples, the contact surface of first electrode 106 is a polygon (e.g., hexagon) with a circumscribed circle having a diameter of or about 0.943 inches. In further embodiments, the contact surface of first electrode 106 may be concave. In some embodiments, the contact surface may be conical or spherically concave. In some embodiments, the contact surface of first electrode 106 may be a concave spherical surface having a radius of curvature, for example, of or about 1.971 inches. In some embodiments, first electrode 106 is a positive electrode and second electrode 108 is a negative electrode. In certain embodiments, one or both of first electrode 106 and second electrode 108 may be made from, for example, copper tungsten alloys which provide high wear resistance against repeated high power electrical discharges. Furthermore, in some embodiments, using electrodes that are constructed from an alloy which is dissimilar to the material of metal conductor 102 may help prevent or avoid fusion or welding of the metal conductor 102 to the electrodes during use.

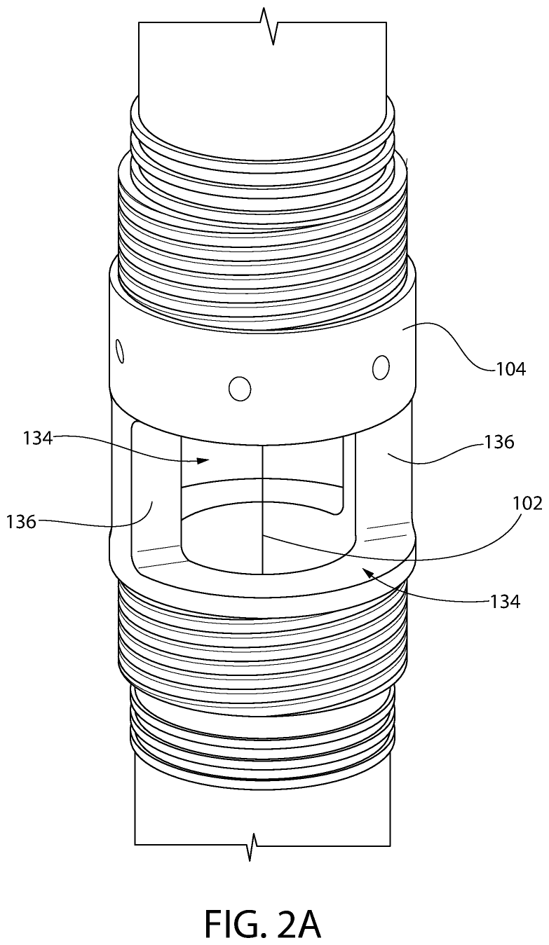

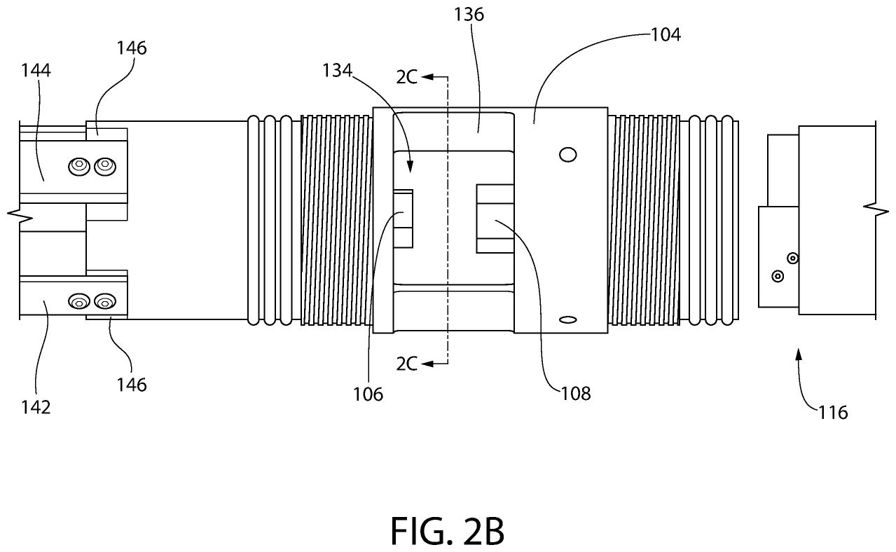

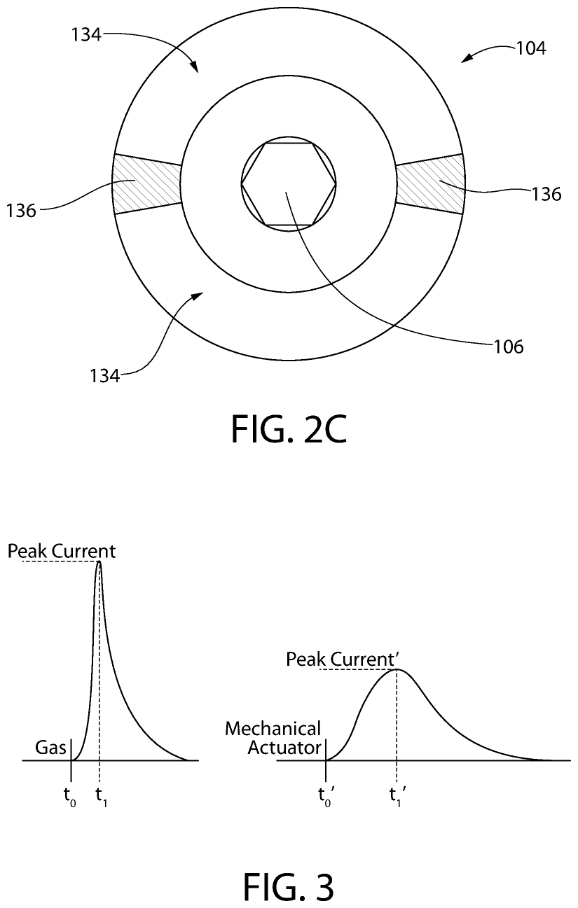

FIGS. 2A-2C show further details of shooting head 104 according to certain embodiments. In some embodiments, shooting head 104 is shaped and configured to prevent redirection or cancellation of the shock wave. In some embodiments, shooting head 104 has a generally circular cross-section (see FIG. 2C) and includes one or more emitter windows 134 which each provide an opening through which the shock waves may be emitted. Shooting head 104 may have, for example, an outside diameter of or about 3.5 inches according to some embodiments. In some embodiments, the one or more emitter windows 134 are radially disposed around the gap between first electrode 106 and second electrode 108, where metal conductor 102 is configured to be inserted and ablated. In some embodiments, shooting head 104 has only a single emitter window 134. In some embodiments, shooting head 104 has no more than two emitter windows 134 through which the shock waves may be emitted. In other embodiments, shooting head 104 has two or more emitter window 134. As shown in FIGS. 2A-2C, in some embodiments, shooting head 104 has two emitter windows 134, which may be diametrically opposed and separated by two struts 136. Each emitter window 134, in some embodiments, may span about 150 degrees to about 170 degrees along the circumference of shooting head 104, for example, 160 degrees. Smaller or larger emitter windows 134 may be used according to other examples.

Referring again to FIG. 1, in further embodiments first electrode 106 is electrically coupled to an energy storage device 110 which is configured to store electrical energy to be discharged to metal conductor 102. Energy storage device 110, in some embodiments, includes at least one capacitor. In some embodiments, energy storage device 110 includes a plurality of capacitors arranged in parallel. In certain particular embodiments, energy storage device 110 includes at least one 60 microFarad capacitor, for example, three 60 microFarad capacitors arranged in parallel.

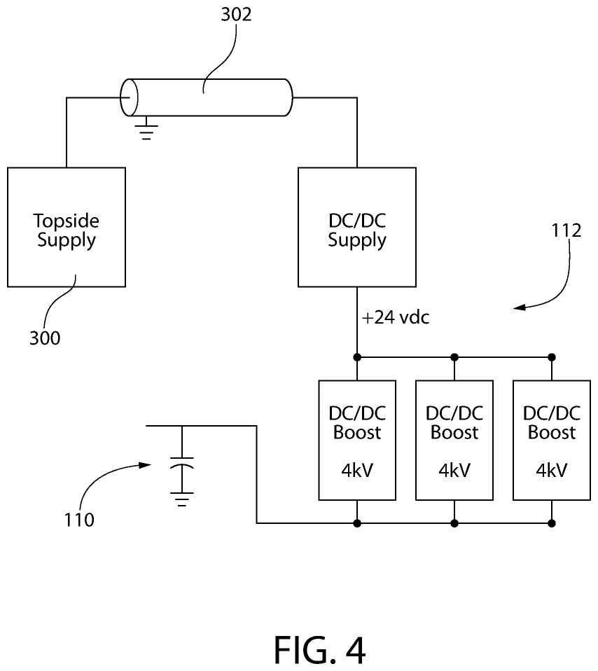

In some embodiments, power may be supplied to plasma pulse device 100, for example, from an external electrical power source 300 (e.g., a low voltage DC power supply) via a conveyance cable 302. The conveyance cable may be a mono-conductor conveyance cable according to some such embodiments which is sized to extend from a power source above the ground surface and into the well bore to plasma pulse device 100 during use. In some embodiments, plasma pulse device 100 further includes various electronics 112 configured to supply the energy from the conveyance cable 302 to energy storage device 110. In some embodiments, electronics 112 includes a power converter (e.g., DC to DC) connected to one or more high voltage step-up power supplies which are connected to energy storage device 110. In some embodiments, electronics 112 is configured to transform a low voltage input DC power (e.g., 185 V min to 400 V max) into a high voltage DC output (e.g., 4000 V), which is stored in energy storage device 110. In certain embodiments, the charging time of storage device 110 is advantageously independent of the length of conveyance cable 302. In some embodiments, for example, energy storage device 110 includes three parallel 60 microFarad capacitors which may be charged to 4000 V in less than 10 seconds. In some embodiments, any high voltage level of the capacitors may be chosen to influence the intensity of the discharge shock wave. In some embodiments, energy storage device 110 is configured to be charged to a maximum of 1500 Joules. A diagram illustrating the electrical layout of plasma pulse device 100 according to an example embodiment is shown in FIG. 4.

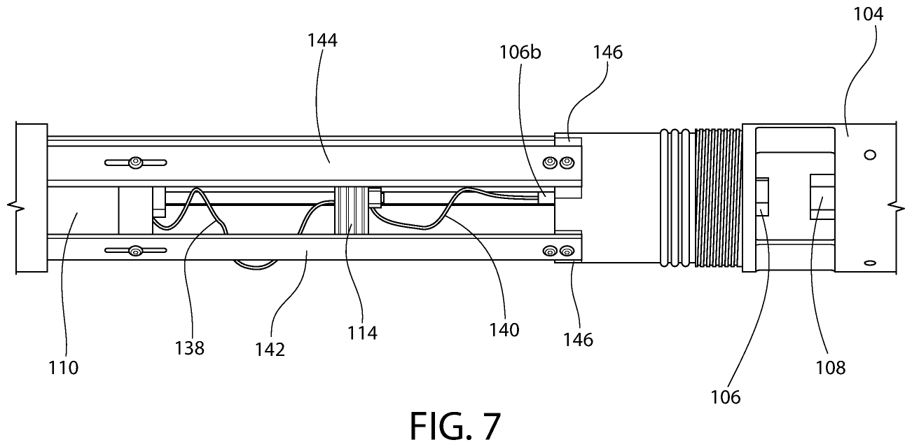

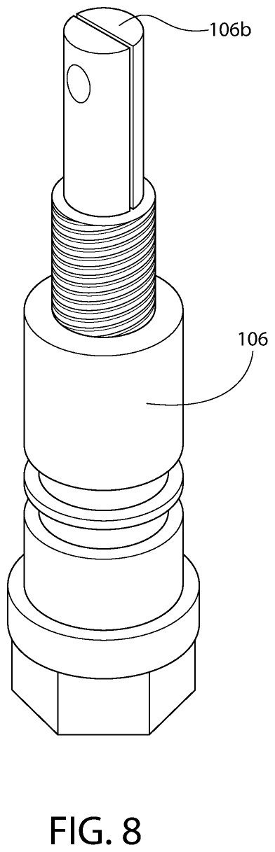

As shown in FIGS. 1 and 7, in some embodiments plasma pulse tool 100 includes a trigger 114 which is configured to transmit the electrical energy from energy storage device 110 to metal conductor 102. In some embodiments, trigger 114 is connected to energy storage device 110 and first electrode 106 and, when actuated, allows the electrical energy from stored in energy storage device 110 to be discharged through first electrode 106 to metal conductor 102. In some embodiments, trigger 114 is connected to energy storage device 110 by a first conductive strap 138 and is connected to first electrode 106 by second conductive strap 140. With further reference to FIG. 8, first electrode 106 includes a slotted end 106b into which second conductive strap 140 may be inserted according to some embodiments. Slotted end 106b may be located opposite the end presenting the contact surface for contacting metal conductor 102 according to some embodiments. In some embodiments, second conductive strap 140 may be secured to first electrode 106 via, for example, a screw passing through slotted end 106b. This high surface area connection between second conductive strap 140 and first electrode 106 allows for high power transfer with minimal losses during discharge according to some embodiments.

In some embodiments, trigger 114 includes a spark gap device. In some embodiments, trigger 114 includes a gas discharge actuator (e.g., a ceramic gas discharge actuator). In some embodiments, the gas discharge actuator is configured to provide a faster current discharge when compared to a mechanical actuator, which allows in a faster rise time and higher peak shock wave pressure. The gas actuator device (e.g., ceramic gas actuator) according to embodiments of the present invention is robust enough to make several thousand repeated pulses without failure and can discharge the stored capacitive energy from energy storage device 110 in about one to three microseconds. In some embodiments, this rapid energy release creates a fast rise time (T0−T1) in discharge current (“compression”) that brings about the higher power in the higher peak current compared to a mechanical actuator. A comparison of relative performance between a gas actuator and a mechanical actuator is illustrated in the graphs of FIG. 3. In some embodiments, the high rise time provided by the gas discharge actuator may allow for the use of a higher melting point material and/or larger diameter for metal conductor 102, which may provide additional advantages such as increased stiffness of metal conductor 102 and improved efficiency in ablation.

Referring again to FIG. 7, in some embodiments plasma pulse tool 100 further includes two or more conductive rails 142, 144 connected to shooting head 104. In some embodiments, conductive rail 142 and conductive rail 144 may be made of different metals, for example, conductive rail 142 is made of copper while conductive rail 144 is made of aluminum. In some embodiments, shooting head 104 is provided with high surface area rail connections 146 for connecting with conductive rails 142, 144. Each rail connections 146 may include, for example, a flattened portion at an end of shooting head 104 configured to abut against one of conductive rails 142, 144. In some embodiments, conductive rails 142, 144 and the high surface area rail connections 146 are configured to lower load circuit resistance which lowers discharge losses and increases output power.

Referring again to FIG. 1, in some embodiments, plasma pulse tool 100 includes a feeder 116 which is configured to feed metal conductor 102 into shooting head 104. In some embodiments, feeder 116 is configured to feed metal conductor 102 into shooting head after each ablation cycle. In some embodiments, feeder 116 includes a supply of the metal conductor 102 and a drive mechanism for conveying the metal conductor 102 from the supply to shooting head 104. In some such embodiments, feeder 116 includes a rotatable spool 118 around which a supply of metal conductor 102 is wound. In further embodiments, feeder 116 includes a drive mechanism 120 which receives the metal conductor 102 from spool 118 and feeds the metal conductor 102 to shooting head 104. In some embodiments, drive mechanism 120 includes one or more motors arranged and configured to move the metal conductor 102 from spool 118 through second electrode 108 and into shooting head 104 until metal conductor 102 sufficiently contacts first electrode 106. In some embodiments, drive mechanism 120 is configured to deliver metal conductor 102 with sufficient force into first electrode 106 to bend the metal conductor 102 to assure a positive contact to the first electrode 106.

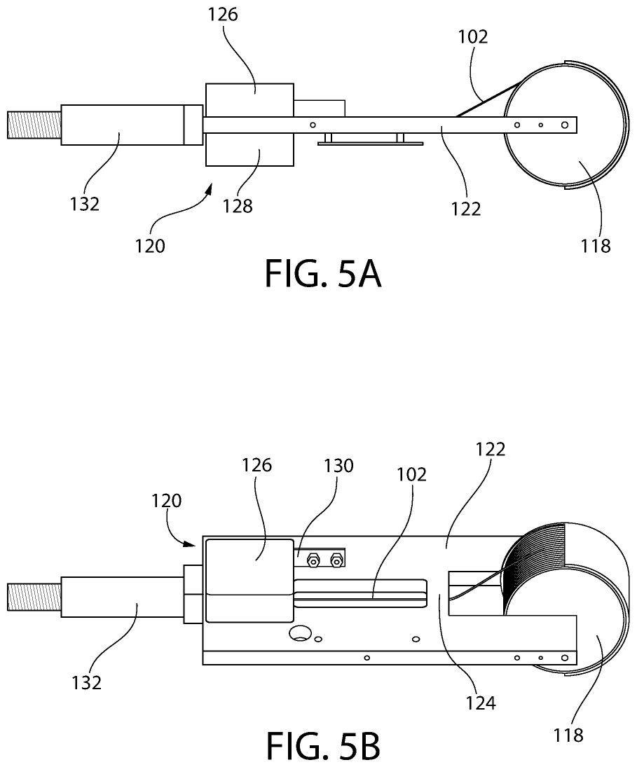

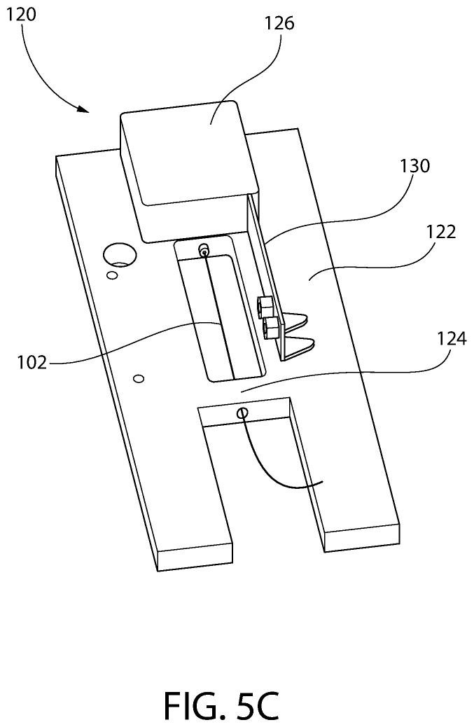

With particular reference to FIGS. 5A-5C, components of feeder 116 such as spool 118 and drive mechanism 120 may be mounted onto a rigid chassis 122 according to certain embodiments. In some embodiments, chassis 122 includes a bifurcated first end on which spool 118 is rotatably mounted, for example, via an axle. In some embodiments, drive mechanism may be mounted on a second end of chassis 122 which is opposite of the bifurcated first end. In certain embodiments, chassis 122 further includes one or more guides 124 which define a passageway for guiding metal conductor 102 from spool 118 to drive mechanism 120. In some embodiments, one or more guide tubes (e.g., stainless steel guide tubes) may also be provided on chassis 122 between spool 118 and drive mechanism 120 through which metal conductor 102 passes. For example, a guide tube may be provided in chassis 122 between guide 124 and drive mechanism 120 such that metal conductor 102 passes from spool 118 through guide 124 and the guide tube before entering the drive mechanism 120. The guide tubes may have, for example, a length of less than one inch (e.g., 0.994 inches) to more than four inches (e.g., 4.562 inches), and may have an outer diameter of less than 0.15 inches (e.g., 0.125 inches). The one or more guides 124 and/or the guide tubes may be sized to have tight tolerances around metal conductor 102. In some embodiments, for example, the tight tolerance may be, a difference of less than 0.01 inches in the diameters of the passageways through guide 124 and/or the guide tubes and metal conductor 102. For example, in some embodiments, passageways may have a diameter of or about 0.022 inches to 0.028 inches for use with a metal conductor 102 having a diameter of or about 0.020 inches. Even smaller tolerances may be provided according to other examples. In some embodiments, the one or more guides 124 and/or guide tubes may help straighten metal conductor 102 and remove any kinks and bends before metal conductor 102 reaches the drive mechanism 120. Straightening metal conductor 102, in some embodiments, allows metal conductor 102 to be presented to the drive mechanism 120 at or approximately center, which in turn increases reliability.

In some embodiments, drive mechanism 120 includes two motors 126, 128 (e.g., stepper motors) which are mounted opposed to each other and configured to receive metal conductor 102 therebetween. In some embodiments, each motor 126, 128 may be sealed to restrict the ingress of foreign material from entering, and the motors 126, 128 may be internally insulated and be configured to operate submerged in water or oil. In certain embodiments, motors 126, 128 each includes a drive wheel which counterrotate at the same speed and/or angular displacement and which are configured to contact and provide constant traction on opposing sides of metal conductor 102. Each drive wheel may be constructed, for example, of hardened steel and each may be provided with circumferential teeth (e.g., gear teeth) to provide better traction against metal conductor 102. Motors 126, 128 may be controlled by circuitry (not shown) which is configured to rotate both motors 126, 128 simultaneously when turned on to deliver the metal conductor 102 smoothly and consistently to shooting head 104 and to turn off the motors 126, 128 until the next demand (e.g., after an ablation cycle).

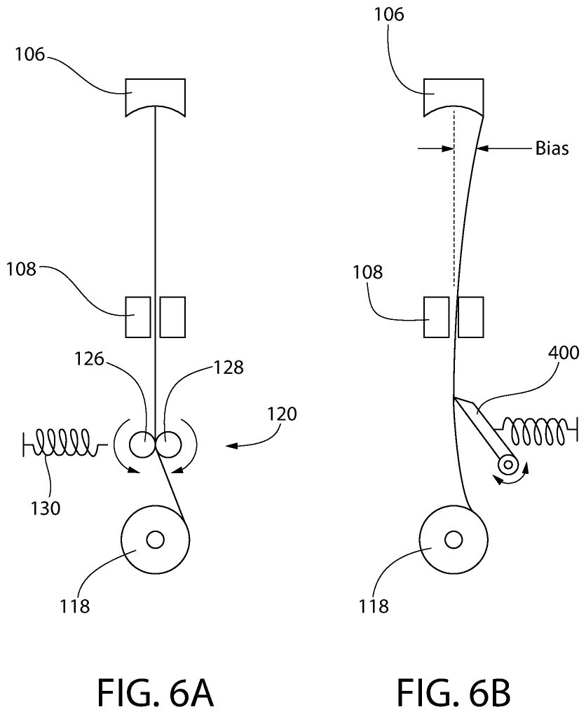

In some embodiments, as illustrated in FIG. 6A for example, the use of twin motors 126, 128 may reduce bias on metal conductor 102 by driving each side of the metal conductor 102 simultaneously so as to not induce a differential mechanical force on just one side. This in turn allows metal conductor 102 to be fed more precisely and accurately into shooting head 104 to make contact with first electrode 106 when compared to a system which utilizes, for example, a push-type actuator 400 as shown in FIG. 6B which may result in a bias and inaccurate positioning of the metal conductor with respect to the electrodes. In some such embodiments, use of the two motors 126, 128 helps metal conductor 102 to be centered with respect to electrodes 106, 108 to ensure sufficient electrode contact and reliability. The use of the two motors 126, 128 according to some embodiments, also contributes to the ability to utilize harder and larger diameter materials (e.g., 0.020 inch diameter or larger stainless steel wire) as the metal conductor 102.

In further embodiments, one or both of the motors 126, 128 may be biased (e.g., spring loaded) toward the other to provide a compressive force against metal conductor 102 and prevent slippage. For example, as shown in the illustrated embodiments, motor 126 may be provided with a biasing element 130 configured to increase tension between motor 126 and motor 128. Biasing element 130 may be a spring, preferably a spring which provides a constant spring force. In some embodiments, biasing element 130 is a cantilever spring. In some embodiments, biasing element 130 is a compression or extension spring. In other embodiments, biasing element 130 is not a compression or extension spring. Motor 128, in some embodiments, does not include a biasing element. In some embodiments, motors 126, 128 are selected to have sufficient torque in order to push metal conductor 102 with enough force into first electrode 106 to bend metal conductor 102 at the point of contact to assure positive contact and preferably without slippage occurring. In some embodiments, the twin drive wheels, the force to bend the metal conductor 102 when it contacts the first electrode 106, and the tight tolerances in the guide tubes collectively may reduce the load path resistance for high efficiency discharges. In further embodiments, feeder 116 includes a hollow stem 132 which is configured to receive metal conductor 102 from motors 126, 128 and guide the metal conductor 102 to second electrode 108. The metal conductor 102 may be inserted repeatedly following an ablation event into the shooter head 104 and between the first and second electrodes 106, 108 by motors 126, 128.

Referring again to FIG. 1, in some embodiments the plasma pulse device 100 of the present invention may include a housing 150 which encloses at least a portion of the components of plasma pulse tube 100. In some embodiments, housing 150 is sized and configured to contain at least energy storage device 110, electronics 112, and feeder 116. In certain embodiments, housing 150, for example, may be generally cylindrical in shape having an outer diameter of about 3.5 inches and a length of about 14 feet long. In some embodiments, housing 150 may be made from stainless steel.

In yet further embodiments, plasma pulse device 100 may further include one or more sensors. In some such embodiments, plasma pulse device 100 has an acoustic sensor that monitors in real time the generation of the plasma discharge. In some embodiments, the acoustic sensor is an electrically independent sensor that only responds to percussive forces transmitted into the plasma pulse device 100 during plasma creation and other device movements. Data may be captured from the acoustic sensor using a classic peak-hold electrical circuit and stored and transmitted to surface, e.g., with telemetry. In some embodiments, this acoustic sensor data when analyzed by itself or when combined with the other monitored electrically dependent information may serve as a positive pulse or positive shot detection device.

In some embodiments, the plasma pulse device 100 includes telemetry equipment, e.g., for frequency shift keying (FSK) telemetry. In some such embodiments, plasma pulse device includes, for example, a 55 kHz beacon that may be precisely timed to the triggering of the plasma discharge and is consistent to within a few microseconds necessary for seismic monitoring purposes. In still further embodiments, plasma pulse device 100 may include additional internal and external sensors for detecting and monitoring, among other things, wellbore fluid properties, casing properties, reservoir properties and depth or time positions within the wellbore.

In use, according to certain embodiments of the present invention, plasma pulse tool 100 may be positioned in a well bore in need of damage remediation. Low voltage input DC power may be supplied to the plasma pulse tool 100 from a power supply 300 via conveyance cable 302. In some embodiments, energy storage device 110 may include a bank of capacitors that may be charged in under 10 seconds. This stored capacitive energy may then be released periodically through a closed loop low resistance load circuit containing the metal conductor 102 (e.g., exploding bridge wire) in shooting head 104. When the electrical energy from the capacitors of energy storage device 110 is discharged via first electrode 106 through the metal conductor 102 over a very short period of time (e.g., less than 5 microseconds), initially the temperature of metal conductor 102 increases rapidly, exceeding its melting point and causing metal conductor 102 to explode or ablate creating an initial plasma channel or wire void. In addition, in certain embodiments, liquids in direct contact with the ablating metal conductor 102 also heat rapidly and a phase change in this liquid occurs from a liquid to a gas. This nearly instantaneous ablation of metal conductor 102 and initial phase change of contact liquid causes a volumetric expansion in a confined space hence the origination of the shock wave, which may be emitted from emitter windows 134 of shooting head 104. In some embodiments, by this process, plasma pulse tool 100 is configured to generate a high power, directed, narrow band, inelastic shock waves. The initial ablation metal conductor 102 and shock wave generation may occur in the first 2% of the discharge time cycle in some embodiments. In some embodiments, the shock wave may be ultrasonic, travelling faster than the speed of sound in the liquid following the ablation discharge. When the shock wave interacts with damage in the well bore (e.g., obstructions or plugs), the shock wave induces physical forces to dislocate and/or break them apart. In the remaining 98% of the pulse discharge sequence, energy from the capacitors continues to flow but without the metal conductor 102 for conductance. In some embodiments, the plasma in the initial discharge channel (wire void plus phase changed contact liquid) acts as the conducting media between the first and second electrodes 106, 108. In this discharge phase the volume of plasma expands like a bubble or inflating balloon sending out low velocity, elastic, wide band acoustic waves that can be used for additional engineering purposes, for example, seismic monitoring. In some embodiments, after each ablation of metal conductor 102, drive mechanism 120 of feeder 116 resupplies shooting head 104 with new metal conductor 102 to allow for the next ablation cycle.

It should be understood that various changes, substitutions, and alterations can be made herein without departing from the spirit and scope of the invention as defined by the appended claims. It should also be apparent that individual elements identified herein as belonging to a particular embodiment may be included in other embodiments of the invention. Moreover, the scope of the present application is not intended to be limited to the particular embodiments of the process, machine, manufacture, and composition of matter, means, methods and steps described in the specification. As one of ordinary skill in the art will readily appreciate from the disclosure herein, processes, machines, manufacture, composition of matter, means, methods, or steps that perform substantially the same function or achieve substantially the same result as the corresponding embodiments described herein may be utilized according to the present invention.

What is claimed is:

1. A plasma pulse device for producing fluid shock waves comprising:
a shooting head including a positive electrode and a negative electrode and at least one emitter window;
a metal conductor configured to be positioned into and ablated in the shooting head; and
a feeder having a drive mechanism for supplying the metal conductor into the shooting head, the drive mechanism including two motors, the metal conductor being at least partially positioned in between the two motors.

2. The plasma pulse device of claim 1, wherein the feeder further includes a chassis having a guide configured to direct the metal conductor to the drive mechanism, the metal conductor being at least partially positioned within the guide.

3. The plasma pulse device of claim 2, wherein the feeder includes a spool rotatably mounted on the chassis, and wherein the guide is positioned between the spool and the drive mechanism.

4. The plasma pulse device of claim 3, wherein the metal conductor comprises a wire which is at least partially wound around the spool.

5. The plasma pulse device of claim 1, wherein the negative electrode includes an aperture configured to receive the metal conductor therethrough.

6. The plasma pulse device of claim 1, wherein the shooting head includes no more than two emitter windows.

7. The plasma pulse device of claim 1, wherein at least one of the positive electrode and the negative electrode are made from a copper tungsten alloy.

8. The plasma pulse device of claim 1, wherein the metal conductor is a stainless steel wire having a diameter of at least 0.020 inches.

9. The plasma pulse device of claim 1, further comprising an energy storage device electrically coupled to the positive electrode and configured to discharge electricity to the positive electrode.

10. The plasma pulse device of claim 9, wherein the energy storage device comprises one or more capacitors.

11. The plasma pulse device of claim 9, wherein the energy storage device is coupled to the positive electrode by a trigger device.

12. The plasma pulse device of claim 11, wherein the trigger device comprises a gas discharge actuator.

13. The plasma pulse device of claim 11, wherein the positive electrode includes a slotted end, wherein the trigger device is connected to the positive electrode by a conductive strap, wherein the conductive strap is inserted within the slotted end of the positive electrode.

14. The plasma pulse device of claim 9, wherein the energy storage device is electrically connected to a DC power supply by a conveyance cable.

15. The plasma pulse device of claim 14, wherein the energy storage device has a charging time that is independent of a length of the conveyance cable.

16. The plasma pulse device of claim 1, wherein the plasma pulse device is configured to generate inelastic shock waves when the metal conductor is ablated in the shooting head.

17. The plasma pulse device of claim 1, wherein the plasma pulse device is configured to generate ultrasonic shock waves when the metal conductor is ablated in the shooting head.

18. The plasma pulse device of claim 1, further including telemetry equipment.

19. The plasma pulse device of claim 18, wherein the telemetry equipment includes an FSK beacon.

20. The plasma pulse device of claim 1, further including a sensor for detecting at least one of plasma discharge, acoustic signals, and/or percussive forces.

21. A method for generating shock waves comprising:
feeding a metal conductor into a shooting head of a plasma pulse device using a drive mechanism including two motors, the metal conductor being at least partially positioned in between the two motors;
contacting the metal conductor to a first electrode positioned in the shooting head; and
delivering electricity to the metal conductor through the first electrode and causing the metal conductor to ablate.

22. The method of claim 21, wherein feeding the metal conductor into the shooting head comprises passing the metal conductor through a second electrode.

23. The method of claim 21, wherein delivering electricity to the metal conductor comprises discharging an energy storage device electrically coupled to the first electrode.

24. The method of claim 23, further comprising charging the energy storage device using a DC power supply.

25. The method of claim 24, wherein the energy storage device comprises one or more capacitors, and wherein charging the energy storage device comprises charging the one or more capacitors in less than ten seconds.

26. The method of claim 23, wherein energy storage device is coupled to the first electrode by a trigger device.

27. The method of claim 26, wherein the trigger device comprises a gas discharge actuator.

28. The method of claim 21, wherein the first electrode is made from a copper tungsten alloy.

29. The method of claim 21, wherein the metal conductor is a stainless steel wire having a diameter of at least 0.020 inches.

30. The method of claim 21, wherein the shooting head includes no more than two emitter windows.
